(19) United States
(12) Patent Application Publication
(10) Pub. No.: US 2003/0228395 A1
(43) Pub. Date: Dec. 11, 2003

(54) Isotropic transparent structured fluids

(75) Inventors: Nissim Garti, Jerusalem (IL); Lewis G. Jacobs, Decatur, IL (US); Branin Lane, Decatur, IL (US); Imad Zakharia, Jerusalem (IL)

Correspondence Address: STERNE, KESSLER, GOLDSTEIN & FOX PLLC, 1100 NEW YORK AVENUE, N.W., WASHINGTON, DC, 20005, US

(73) Assignee: Archer-Daniels Midland Company

(21) Appl. No.: 10/352,252

(22) Filed: Jan. 28, 2003

Related U.S. Application Data
(60) Provisional application No. 60/414,360, filed on Sep. 30, 2002.
(60) Provisional application No. 60/352,544, filed on Jan. 31, 2002.

(51) Int. Cl. A23K 1/175

(52) U.S. Cl. 426/74

(57) ABSTRACT

Disclosed are vitamin, mineral and nutrient delivery systems, and in particular beverage and solid food compositions and methods for the enhanced solubilization and delivery of fat-soluble compositions.

### BACKGROUND OF THE INVENTION

1. Field of Invention

The present invention relates to vitamin, mineral and nutrient delivery systems, and in particular beverage and solid food compositions and methods for the enhanced solubilization and delivery of fat-soluble compositions.

2. Background Art

Supplementation of beverages and other drinks with various nutrients is important as consumer demand for such grows. Such supplementation is an important means for delivery of important nutrients and vitamins for those lacking in essential diets or unable to uptake vitamins and minerals by conventional methods. Nutritionally fortified products, including the most popular herbal, vitamin and mineral combinations, are important sources of additional nutrients to consumers, as nutrient beverages often allow the nutrient to act on the body quickly.

In general, the scientific art has long attempted to address the problems associated with finding a suitable media to render fat soluble vitamin compositions dispersible in aqueous solutions. The most common of these approaches include taking advantage of the increased solubility of many fat-soluble vitamins in oils (such as triglycerides) from a vegetable source. These approaches often envisage use of a surfactant to solublize the triglyceride containing oil composition to disperse it in an aqueous environment. The primary drawback of such inventions is that the beverage being supplemented often displays enhanced turbidity or the presence of a “milky” or “cloudy” appearance that changes certain characteristics of the beverage. Another problem associated with such supplementation is the phenomenon referred to in the literature as “ringing,” which involves the formation of a separate fat soluble vitamin layer at the top of the liquid. A common example of such a phenomenon is the occasional appearance of a red layer on top of vitamin D fortified milk cans, which arises due to the separation of the supplemented vitamin D layer. This is because emulsions are thermodynamically unstable and colloidal emulsions spontaneously agglomerate, leading to eventual phase separation. Such behavior leads to poorly characterized and potentially unwelcome supplemented beverages that are not liked by consumers.

Numerous possible approaches for addressing these problems have been reported in literature. Some of these include using high pressures (up to 60,000 psi) to produce vitamin droplets which are about 700 to about 200 nanometers in diameter dispersed in a polysaccharide matrix (U.S. Pat. No. 6,162,474), using liposomes to encapsulate the vitamins, or using triglycerides and surfactants to provide stable emulsions (U.S. Pat. No. 6,267,985). Other approaches have also included using polyethoxylated castor oils or using amphiphilic and cationic liquids (U.S. 2001/0028887). A further approach includes derivatizing the vitamin molecule to enhance its hydrophilicity (WO 99/62896; WO 02/062392). However, these approaches do not provide clear water dispersible beverage formulations and are limited either by the processing conditions (high pressures) or choice of solvents (potential health hazards).

### SUMMARY OF THE INVENTION

It is, therefore, an object of this invention to provide a liquid composition of fat-soluble vitamins or esters thereof which may be added to beverages in nutritionally supplemented amounts without affecting the optical clarity or stability of such nutritionally supplemented beverages.

It is another object of this invention to provide a delivery system for vitamins and esters thereof to solid food compositions such as energy bars, hard candies, gummy type candies, gelatin desserts, dried fruit type candies, flavor emulsions, dried juice concentrates, dried drink concentrates and other similar applications.

It is another object of this invention to provide dietary or nutritional supplement compositions, which are capable of solubilizing fat soluble vitamin compositions of high potency, which will, at the same time remain stable under normal or ordinary conditions of use.

Another object of this invention is to provide a vitamin supplement composition which does not alter the sensory properties of the composition to which it is added, and which provides enhanced bioavailability and does not cause ringing in the supplemented beverage. Such supplements or beverages supplemented therewith may include, but are not limited to, fruit and vegetable juices, vitamin drinks, mineral or clear bottled water, energy drinks, sports drinks, carbonated beverages, meal replacement drinks, punches and concentrated forms of beverages.

Another object of this invention is to provide for the manufacture of a dried powder which upon mixing with an aqueous phase results in the formation of isotropic transparent solution which provides a mechanism for the supplementation of the said fat soluble vitamin and which will at the same time remain stable under normal or ordinary conditions of use. Such products may be prepared using the nano-emulsion technology described under the embodiments of this invention and may be used in a dry or a concentrate form.

It is another object of this invention is to provide beverage and solid food compositions comprising a nutritional amount of a fat-soluble vitamin in the form of an isotropic transparent solution.

Other objects and embodiments of the present invention will be apparent to those skilled in the art form and from the descriptions, which follow herein.

Therefore, the present invention relates to certain novel vitamin and mineral compositions, more specifically to non-aqueous, stable, readily water-dispersible vitamin compositions that provide a clear stable emulsion and do not alter the visaul characteristics of the material into which it is being dispersed. The vitamins useful in the practice of this invention are fat-soluble (or sometimes referred to as oil-soluble) vitamins such as tocopherol homologues, tocotrienol homologues or their esters or combinations thereof. A more specific application of this invention relates to the manufacture of clear water dispersible beverage emulsions of vitamin E, or one of its esters such as vitamin E acetate.

In accordance with the present invention, the forgoing objects are achieved by the utilization of micro-emulsions to provide such vitamin supplements. Micro-emulsions are single continuous phase (also referred to as isotropic), thermodynamically stable, structured fluid compositions of two immiscible liquids such as fat and water which are brought into a single phase instantaneously and spontaneously by the interaction of an appropriate surfactant or a mixture of surfactant and co-surfactant or co-solvent. Such micro-emulsions produced according to the embodiments of this invention are between 1-100 nanometers in diameter and may also be referred to as nano-emulsions.

According to one of the embodiments of this invention, compositions resulting from the present invention provide a clear concentrate containing vitamin E or esters thereof which, when solubilized, are clear and dilutable in aqueous compositions at all concentrations.

For example, in the present compositions the fortified supplements can provide the nutritional equivalent of at least 30 International Units (IU) of vitamin E or more preferably 100 IU or more, which is in accordance with the published dietary regulatory guidelines on such vitamins or supplements. It is to be understood that this invention in no way limits the amount of the vitamin supplement which may be provided in the beverages or solid food products; those of skill in the art will recognize that the amount is usually modified to suit the prevailing nutrient guidelines.

### BRIEF DESCRIPTION OF THE DRAWINGS/FIGURES

FIG. 1A. Phase behavior for the D-limonene/ethanol system chosen for tocopherol solubilization. The isotropic region where a single phase exists is 64% of the total phase diagram area. At lines 7.3 and 8.2 which indicate a ratio of TWEEN 60:oil phase (D-limonene/ethanol) of 7:3 and 8:2, respectively, the micro-emulsion is shown to be infinitely dilutable with water. Along line w82 the micro-emulsion is shown to be completely dilutable by the oil phase. There are many compositions that are dilutable both with water and oil (see point A).

FIG. 1B. Phase diagram containing tocopherol acetate as 12.5% of the oil phase. The single phase isotropic region is 62.5% of the total phase diagram area. Numerous compositions containing 12.5% tocopherol acetate in the oil phase are shown to be completely dilutable with water and oil.

FIG. 1C. Phase diagram containing tocopherol acetate as 25% of the oil phase. The single phase isotropic region is 60.6% of the total phase diagram area. Dilutable micro-emulsions are shown to be formed equivocally with the more concentrated tocopherol acetate mixtures.

FIGS. 2A-2D. Phase behavior for the MCT/ethanol system chosen for tocopherol solubilization. A_{T}: Total Monophasic area; Wₘ: Maximum amount of solubilized water.

FIG. 3. Phase behavior for the triacetin/ethanol system chosen for tocopherol solubilization.

FIGS. 4A-4D. Phase diagrams of the four forms of vitamin E (tocopherol acetate (Toe. Ac.), alpha-tocopherol (Toe. OH), mixed tocopherols (Mxd Toc. OH), mixed tocotrienols (Mxd Toc-3-OH)) with TWEEN 60 as surfactant and water/1,2-propanediol as co-surfactant.

FIGS. 5A-5D. Phase diagrams of tocopherol acetate (Toe. Ac.) and tocopherol (Toe. OH) with TWEEN 60 or TWEEN 80 as surfactant and water as co-surfactant (in the absence of 1,2-propanediol).

FIG. 6. Solubilization capacity of the four forms of vitamin E: tocopherol acetate (Toc. Ac.), alpha-tocopherol (Toe. OH), mixed tocopherols (Mxd Toe. OH), mixed tocotrienols (Mxd Toc-3-OH). The values assign the maximum amount of vitamin E that can be solubilized as a wt/wt percentage of the total micro-emulsion weight.

FIG. 7. Solubilization capacity of alpha-tocopherol (Toc. OH) and alpha-tocopherol acetate (Toc. Ac.) with two types of oils: D-limonene and triacetin.

### DETAILED DESCRIPTION OF THE INVENTION

The present invention is related to a liquid micro-emulsion of a fat soluble vitamin which when added to a liquid provides a nutrient supplement containing the vitamin which is optically clear and remains so for all practical purposes under normal conditions. The emulsion of the invention may also be added to liquids which are not optically clear such as fruit or vegetable juices, energy drinks and meal replacement drinks. However, the emulsion of the present invention does not, upon addition, affect the clarity or turbidity of the beverage.

The present invention is further related to a liquid micro-emulsion of a fat soluble vitamin which can be used as a delivery system for vitamins and esters thereof to solid food compositions such as energy bars, hard candies, gummy type candies, gelatin desserts, dried fruit type candies, flavor emulsions, dried juice concentrates, dried drink concentrates and other similar applications.

The fat soluble vitamin described in this invention may be vitamin E, tocotrienol, their homologues or esters such as vitamin E acetate, vitamin A or its ester (such as vitamin A acetate or vitamin A palmitate), vitamin K (phytomenadione) or vitamin D₃ (cholecalciferol). Alternatively, the fat soluble vitamin may be blended together with a vegetable oil such as corn or soybean oil or other mineral or vegetable oil. Thus, the emulsion so produced may contain one or more of the vitamins in pure form, or with appropriate diluents, so as to maintain the dosage requirements of the vitamin. Preferably, the fat soluble vitamin is selected from the group consisting of vitamin E and its homologues or esters and mixtures thereof. More preferably, the fat soluble vitamin is vitamin E and its esters. Even more preferably, the fat-soluble vitamin is vitamin E acetate, which may be synthetic vitamin E acetate or natural source vitamin E acetate.

The micro-emulsion of the present invention results from the unique combination of three components. The three components each contribute to the thermodynamic stability and clear aqueous dispersability of the nutritional supplement. The main component of the micro-emulsion is the oil phase, which contains the necessary vitamin supplement (in natural form or esters thereof). This phase is mixed with surfactants, which provide it with the necessary characteristics to form a micro-emulsion in the aqueous phase. The aqueous phase acts as a carrier for the addition of the vitamin supplement to a water-based beverage or solid food composition.

The oil phase may consist of D-limonene, medium chain triglycerides (MCT), long chain triglycerides, triacetin or other oil along with the vitamin or its homologues or one of its esters or combinations thereof. A primary alcohol is also used in the oil phase to act as a co-surfactant for creation of the nano-emulsion. However a secondary or tertiary alcohol may also be substituted. The aqueous phase consists of water and may further comprise polyol co-solvents such as 1,2-propanediol or glycerol. According to one of the embodiments of this invention the 1,2-propanediol may be substituted with lactose or a similar sugar alcohol, which will aid in the formation of a spray dried powder suitable for manufacture of isotropic nano-emulsions.

The surfactant phase may include, for example, polyoxyethylene derivatives of sorbitan monoester, such as a polyethylene oxide of sorbitan fatty acid esters (sorbitan monopalmitate, sorbitan monooleate, sorbitan monostearate, etc.). These compounds are available under the commercial trademark of “TWEEN” of Atlas Powder Company (a Delaware Corporation) such as TWEEN 60 or TWEEN 80. Alternative surfactants may also be used such as polyglycerol monoesters, typically triglycerol monooleate, or sucrose esters, typically sucrose acetate isobutyrate (SAIB). The triglycerol monooleate or SAIB may also be mixed with TWEEN 60 or TWEEN 80 to enhance the solubilization properties of the nano-emulsion. It must be emphasized that purity of the various components is extremely important. For example, other triglycerides such as soybean oil, canola oil, sunflower oil, and corn oil may be substituted in the oil phase. In such cases care must be taken to winterize such vegetable oils; otherwise they will allow for appearance of a cloudy haze, in part due to the presence of waxy material in the oil. Similarly, the surfactants used must not be contaminated with other insoluble components which may contribute towards a cloudy nano-emulsion.

As those of skill in the art will now recognize, in light of the present disclosure, there are many combinations of oils, solvents, co-solvents, surfactants, and co-surfactants that will yield clear, continuous phase micro-emulsions. Those skilled in the art will arrive at one or more desired combinations based on the knowledge imparted in this disclosure. This invention covers all such combinations of solvent systems, which yield a clear infinitely water dilutable system of aforesaid vitamin compositions.

Optical clarity of the prepared emulsions is measured by a visual comparison. Appearance of “milky” or “cloudy” layers is generally indicative of poor emulsion and usually affects the beverage or food product being supplemented. After complete mixing, which takes a few minutes, the dispersion is optically clear and any resulting foam due to air entrapment is quickly dissipated. According to one of the embodiments of this invention, the micro-emulsion so prepared may be added to beverages which are not optically clear or partially or completely opaque. However, subsequent to supplementation or fortification with the vitamin, no ringing is observed, and bioavailability is increased. Although the methods described in this invention may be used to prepare optically turbid or “milky” emulsions it is one object of this invention to prepare such emulsions which are optically clear and do not contain any foam or suspended matter, are free of ringing, and are stable under normal conditions of use.

Preferably, the components used to make the emulsion are at least acceptable for animal/human consumption and are of GRAS (generally recognized as safe) status. Such materials are certified for food use as determined by regulatory agencies. For instance, a preferred alcohol used in the practice of the invention is beverage grade ethanol, which is completely free of other contaminants or components and is suitable for human or animal consumption. Beverage grade ethanol may be used without any dilution with water, or with water content between 0 to 100%; preferably at a concentration of ethanol between 50 and 100% by volume; more preferably between 70 and 100% by volume. Other primary alcohols are not certified for human or animal consumption and may not be used if the product is designated for such. For instance, methanol, 2-propanol or 1-propanol or combinations thereof may also be used.

In accordance with the process employed for preparing these compositions, the fat-soluble vitamin is first blended with an oil such as D-limonene, MCT, or triacetin along with an alcohol such as ethanol. The aqueous phase is then blended separately using water and, optionally, a polyol such as 1,2-propanediol. Alternatively, other polyols such as 1,3-propanetriol, lactose, xylitol, sorbitol, or glucose may also be used. Finally, the oil and the aqueous phases are blended together using a surfactant such as TWEEN 60 or TWEEN 80. The emulsion may then be diluted with water to supplement any nutritional beverage or solid food as described in this invention. Caution must be exercised during the course of blending so that aeration of the mixture is minimized to prevent oxidative degradation of the vitamin components. Even in cases where the vitamin components are stable against oxidation, such as vitamin E acetate, aeration should be minimized. Any foaming resulting from the blending is quickly dispersed due to the stability of the micro-emulsion, and an optically clear concentrate is obtained. The compositions prepared according to this invention have been found to be stable at room temperature for extended periods of time and with elevated temperature or refrigerated conditions.

It has been also discovered that a water dispersible powder can also be produced according to the embodiments of this invention. In accordance with the process employed for preparing a powder, the vitamin in the oil phase is mixed in the absence of ethanol with the surfactant and the aqueous phase, which may contain a sugar alcohol such as lactose along with water. The nano-emulsion so obtained is then dried to remove the water, preferably with a spray dryer although other drying mechanisms such as freeze-drying may accomplish the same result. The powdered product produced by this method upon dissolving provides an isotropic transparent structured fluid, which may be used to prepare various supplements.

The various embodiments of this invention provide stable micro-emulsions of one or more fat-soluble vitamins, prepared without significant mechanical or thermal input, which are clear and stable against oiling or ringing. The following examples are illustrative in nature and are not to be construed as limiting the invention, the scope of which is defined by the appended claims.

### EXAMPLE 1

### Micro-emulsions of Tocopherol Acetate in D-limonene/Ethanol

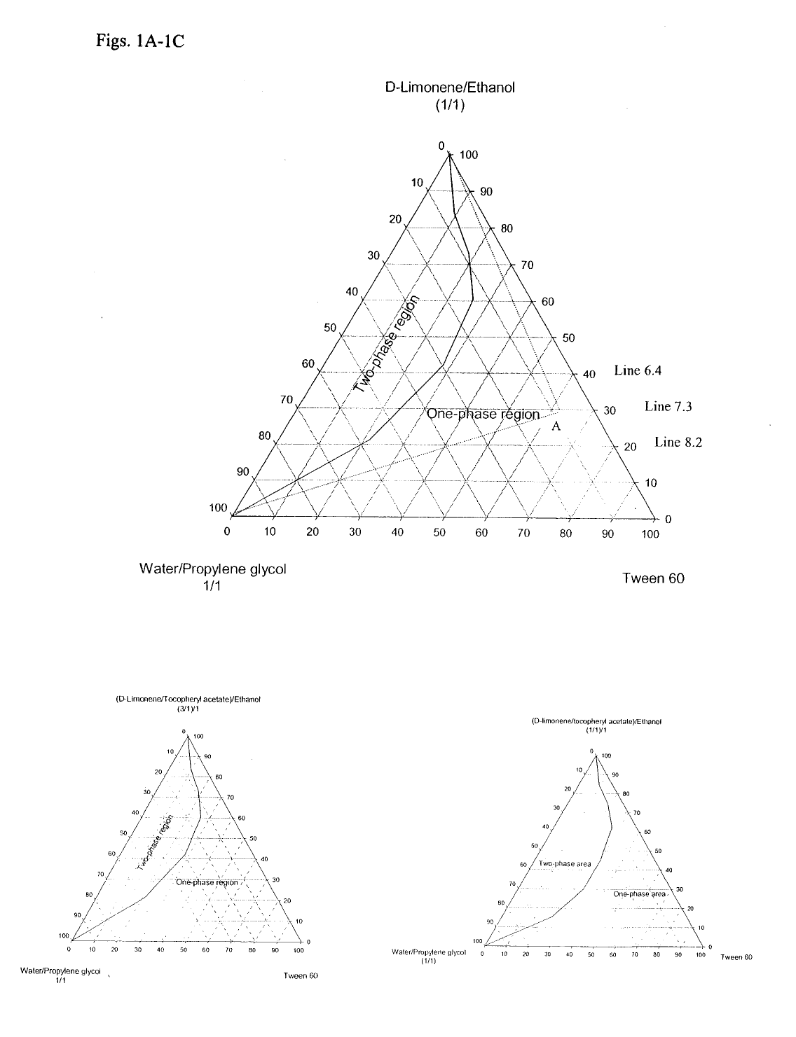

In a thermostable temperature bath kept at 25° C., tocopherol acetate was solubilized in an oil phase of D-limonene and beverage grade ethanol (100% v/v) with Tween 60 as surfactant and an aqueous phase of water and 1,2-propanediol or water and glycerol. Phase diagrams with these compositions were prepared and the solubilized micro-emulsions were prepared according to the isotropic region indicated by the phase diagram (FIGS. 1A-1C). The results are given in Table 1.

TABLE 1

| Slope of | | Oil Phase | | | Tocopherol | |
|---|---|---|---|---|---|---|
| line | Aqueous | (D-limonene/ | | Aqueous | Acetate | |
| phase | phase (% | Ethanol | | Phase | solubilized | |
| diagram | of total) | Ratio) | Surfactant | (Ratio) | (%) | Comments |
| 6.4 | 60 | 1:1 | TWEEN 60 | Water/1,2- | 1 | Infinitely |
| | | | | Propanediol | | dilutable |
| | | | | (1:1) | | |
| 6.4 | 60 | 1:1 | TWEEN 60 | Water/1,2- | 6.54 | Nondilutable |
| | | | | Propanediol | | |
| | | | | (1:1) | | |
| 7.3 | 80 | 1:1 | TWEEN 60 | Water/1,2- | 0.92 | Infinitely |
| | | | | Propanediol | | dilutable |
| | | | | (1:1) | | |
| 7.3 | 70 | 1:3 | TWEEN 60 | Water/1,2- | 2.92 | Infinitely |
| | | | | Propanediol | | dilutable |
| | | | | (1:1) | | |
| 7.3 | 70 | 1:3 | TWEEN 60 | Water/1,2- | 3.36 | Infinitely |
| | | | | Propanediol | | dilutable |
| | | | | (1:1) | | (transparent over |
| | | | | | | 60% dilution) |
| 7.3 | 70 | 1:1 | TWEEN 60 | Water/1,2- | 1.74 | Infinitely |
| | | | | Propanediol | | dilutable |
| | | | | (1:1) | | |
| 7.3 | 60 | 1:1 | TWEEN 60 | Water/1,2- | 3.1 | Infinitely |
| | | | | Propanediol | | dilutable |
| | | | | (1:1) | | |
| 7.3 | 50 | 1:1 | TWEEN 60 | Water/1,2- | 3.1 | Infinitely |
| | | | | Propanediol | | dilutable |
| | | | | (1:1) | | |
| 7.3 | 50 | 1:1 | TWEEN 60 | Water/1,2- | 6.8 | Infinitely |
| | | | | Propanediol | | dilutable |
| | | | | (1:1) | | (transparent over |
| | | | | | | 80% dilution) |
| 7.3 | 50 | 1:3 | TWEEN 60 | Water/1,2- | 7.6 | Infinitely |
| | | | | Propanediol | | dilutable |
| | | | | (1:1) | | (transparent over |
| | | | | | | 80% dilution) |
| 7.3 | 60 | 1:3 | TWEEN 60 | Water/1,2- | 3.1 | Infinitely |
| | | | | Propanediol | | dilutable |
| | | | | (1:1) | | |
| 7.3 | 60 | 1:1 | TWEEN 80 | Water/ | 3.1 | Infinitely |
| | | | | Glycerol | | dilutable |
| | | | | (3:1) | | |
| 7.3 | 60 | 1:3 | TWEEN 80 | Water/ | 3.1 | Infinitely |
| | | | | Glycerol | | dilutable |
| | | | | (3:1) | | |
| 6.4 | 70 | 1:3 | TWEEN 60 | Water/1,2- | 1 | Nondilutable |
| | | | | Propanediol | | |
| | | | | (1:1) | | |
| 6.4 | 50 | 1:1 | TWEEN 60 | Water/1,2- | 3.9 | Infinitely |
| | | | | Propanediol | | dilutable |
| | | | | (1:1) | | (transparent over |
| | | | | | | 85% dilution) |

### EXAMPLE 2

### Micro-Emulsion of Tocopherol Acetate in MCT/Ethanol

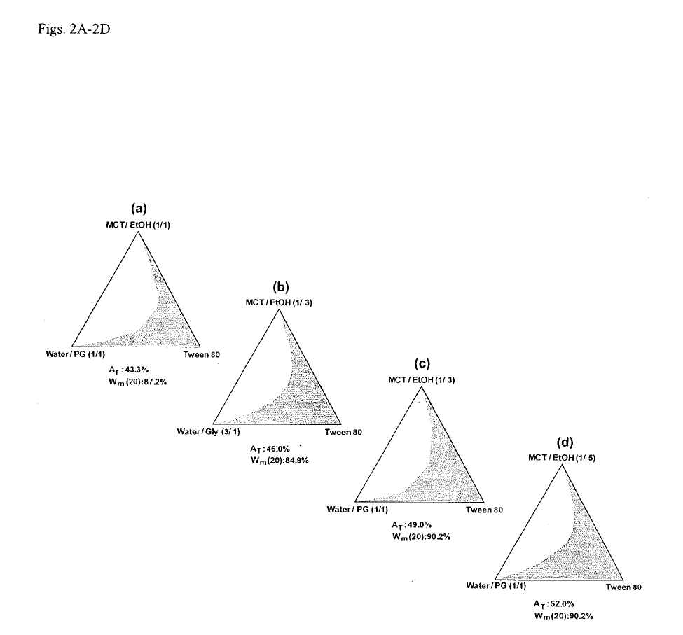

D-limonene from Example 1 was replaced with medium chain triglycerides. Due to the fact that D-limonene has an odor, which can be undesirable for some food applications, medium chain triglycerides were used in the compositions of Example 1 and phase diagrams were prepared (FIG. 2) to identify the isotropic regions. Medium chain triglycerides are fully saturated and stable to oxidation. They are odorless, non-viscous, and colorless and do not disrupt the solubilization. Solutions were then prepared in the isotropic region as identified by the phase diagrams and the key results are shown in Table 2.

TABLE 2

| Slope of | | Oil Phase | | | Tocopherol | |
|---|---|---|---|---|---|---|
| line | Aqueous | (MCT/ | | Aqueous | Acetate | |
| phase | phase (% | Ethanol | | Phase | solubilized | |
| diagram | of total) | Ratio) | Surfactant | (Ratio) | (%) | Comments |
| 8.2 | 60 | 1:3 | TWEEN 80 | Water/1,2- | 1.26 | Infinitely |
| | | | | Propanediol | | dilutable |
| | | | | (1:1) | | |
| 8.2 | 60 | 1:3 | TWEEN 80 | Water/1,2- | 2.2 | Infinitely |
| | | | | Propanediol | | dilutable |
| | | | | (1:1) | | (transparent over |
| | | | | | | 50% dilution) |
| 7.3 | 50 | 1:3 | TWEEN 80 | Water/1,2- | 1.72 | Infinitely |
| | | | | Propanediol | | dilutable |
| | | | | (1:1) | | (transparent over |
| | | | | | | 70% dilution) |

### EXAMPLE 3

### Micro-Emulsions of Tocopherol Acetate in Triacetin/Ethanol

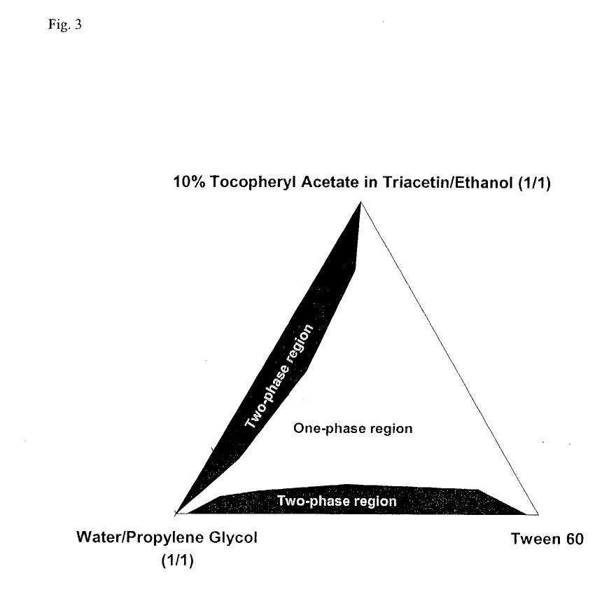

This example describes preparation of a clear micro-emulsion of tocopherol acetate using triacetin in the oil phase. Based on the information from the isotropic region of the phase diagram (FIG. 3) the following soluble composition was prepared by blending the components described in Table 3.

TABLE 3

| Component | Weight (grams) |
|---|---|
| Tocopherol Acetate | 19.49 |
| Triacetin | 20.00 |
| Ethanol (100%, v/v) | 20.00 |
| TWEEN 60 | 60.00 |
| 1,2-Propanediol | 25.00 |
| Water | 25.00 |
| Total | 169.49 |

The emulsion prepared as described in Table 3 was clear and infinitely dilutable in water. It was stable under normal conditions of storage and use.

### EXAMPLE 4

### The Effect of pH on Stability of Micro-Emulsions

Micro-emulsions containing the maximum amount of tocopherol acetate were chosen with slope of line of 6.4 from Example 1 with different dilutions along the line (50%, 60%, 70%, and 80%). A buffer of different pH values (3.4, 3.8, 5.4, 7.0 and 8.6) replaced the water in the aqueous phase. All of the samples were found to be stable for over two months. Hence, it was demonstrated that tocopherol acetate solubilized in a five component micro-emulsion of D-limonene, ethanol, TWEEN 60, 1,2-propanediol and water maintains its stability over a large pH range, supporting its applicability to beverages and solid food compositions with various pHs.

### EXAMPLE 5

### Phase Behavior of Different Forms of Vitamin E

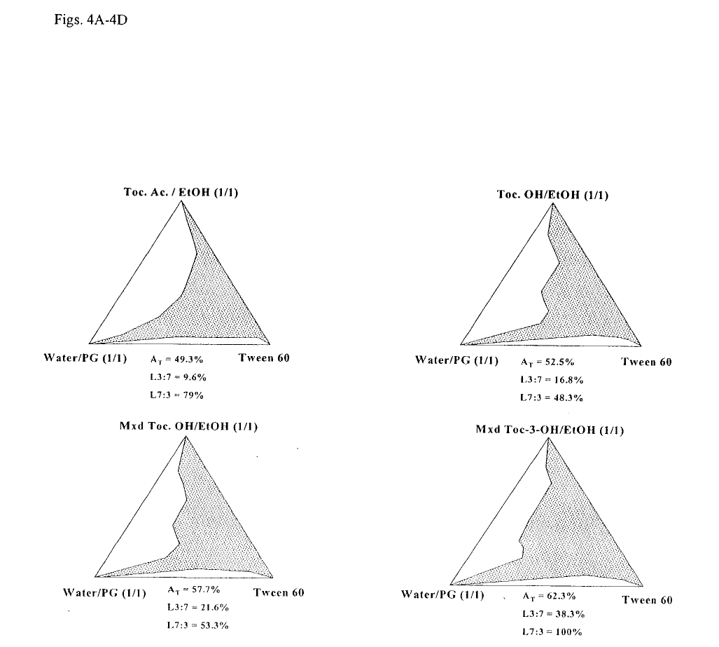

The phase behavior of the four types of vitamin E has been compared (FIGS. 4A-4D), where the system is composed of vitamin E/ethanol (1/1), TWEEN 60 as a surfactant and water/1,2-propanediol (1/1) as the aqueous phase. It can be observed from FIGS. 4A-4D that the solubilization capacity for water and oil runs in the following order: mixed tocotrienols >mixed tocopherols >alpha-tocopherol >tocopherol acetate. If the phase behavior is compared to that of D-limonene, it can be seen that when the vitamin is esterified, there is an overall decrease in the dilution capacity at almost all surfactant concentrations. On the other hand, the alcohol forms of the vitamin (those having a free OH group) show a higher solubilization capacity of water in the oil corner and an opposite effect at the water corner (although there are some dilutable formulations). Upon reducing one or two methyl groups from the vitamin (mixed tocopherols), a slightly higher solubilization capacity is achieved, which suggests more convenient interactions of the vitamin with the interface arising from less steric hindrance caused by the methyl groups. When the phytyl tail of the vitamin is unsaturated (as in tocotrienols), an additional improvement in the solubilization capacity of water and oil is achieved, indicating more efficient interactions of the vitamin in the interface.

### EXAMPLE 6

### Lower Levels of Surfactant

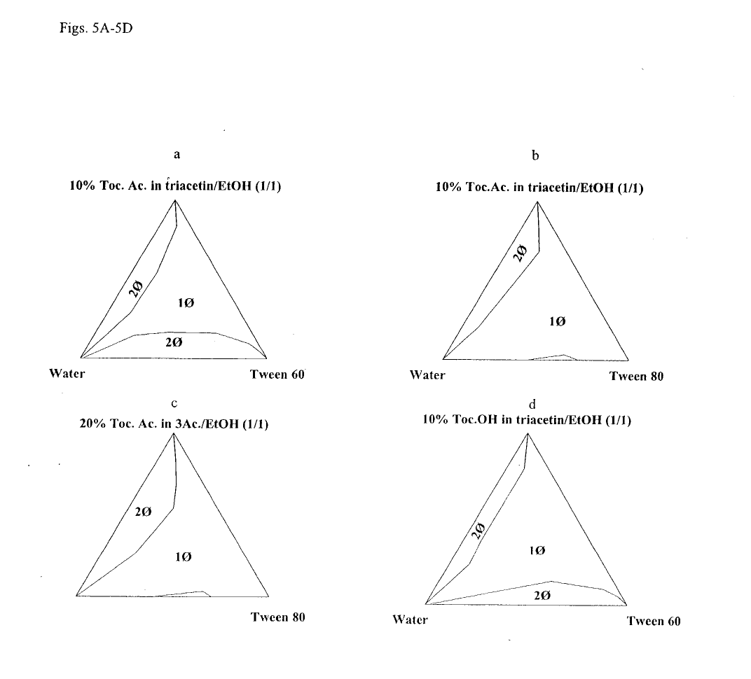

In the previous examples, the vitamin concentrates which can be dilutable with water contain relatively high concentrations of TWEEN. In an attempt to reduce the level of surfactant by increasing the level of oil, the vitamin was introduced to the oil phase replacing a fraction of triacetin/ethanol (1/1), i.e., the vitamin is part of the oil phase and it is included in the calculations (FIGS. 5A-5D). In the systems shown in FIGS. 5A, 5B and 5D the concentrate can be diluted with water along line 6:4. When using TWEEN 80 the 2-phase region between the surfactant and water is significantly reduced, due to higher solubility of TWEEN 80 in water than TWEEN 60 in water.

### EXAMPLE 7

### Micro-emulsions of Tocopherol Acetate Without Surfactant

This example illustrates preparation of a stable nano-emulsion based on a phase diagram without the use of surfactant.

An emulsion was prepared with the following concentrations.

| Component | Concentration (%, w/v/) |
|---|---|
| Tocopherol Acetate | 17.5 |
| Ethyl Alcohol | 17.5 |
| Polysorbate 60 (BASF T-MAZ 60) | 65 |
| Total | 100 |

The emulsion prepared was infinitely dilutable in water and stable under pH 2-12 at room temperature and under refrigerated conditions.

### EXAMPLE 8

### Solubilization Capacity of Vitamin E

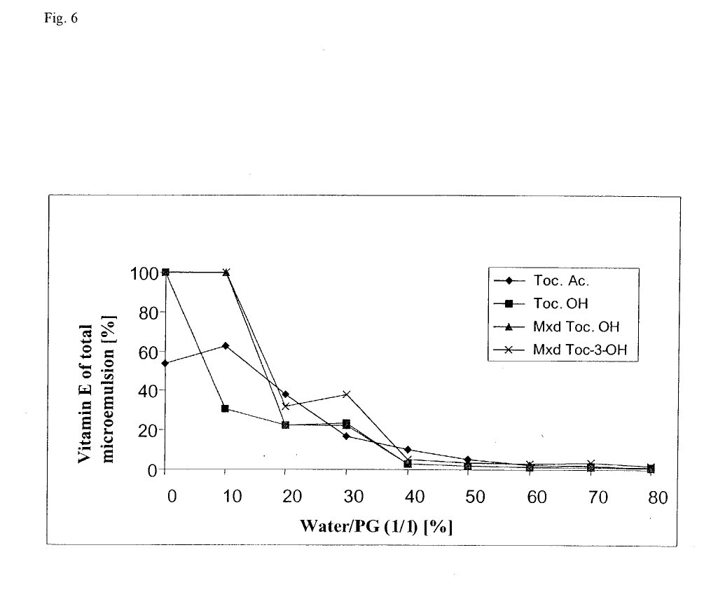

The maximum amount of vitamin E solubilized was compared among the different forms of vitamin E along line 6:4 in the five-component system of D-limonene/ethanol (1/1) as the oil phase, TWEEN 60 as surfactant, and water/1,2-propanediol (1/1) as the aqueous phase, in order to obtain insight into the difference in their interfacial behavior (FIG. 6).

The solubilization capacity of tocopherol acetate decreases along all the dilution concentrations after 10%. Alpha-tocopherol and mixed tocopherols show two main dramatic decreases in solubilization, after which a stabilization in solubilization is maintained. However, these drops in solubilization may indicate a relation to the type (W/O, bicontinuous, O/W) and structure of the micro-emulsion. Hence, it can be seen that the esterified vitamin is less dependent on the structure of the micro-emulsion, for its solubilization decreases continuously along the dilution line, while the free tocopherols show some dependence on the type and structure of the micro-emulsion. The drastic drops in solubilization may suggest structural transitions of the micro-emulsion. The first drop in solubilization, which could be referred to transition from W/O to bicontinuous micro-emulsion, for mixed tocopherols is somehow delayed to higher concentrations of aqueous phase, which may indicate a more efficient penetration of the vitamin within the interface, thus increasing the size of the droplets, and allowing more aqueous phase to be solubilized. In fact, this is consistent with composition of the mixed tocopherols, which have a major component of gamma-tocopherol that has one methyl group less than the alpha-tocopherol. The second drop in solubilization of alpha-tocopherol and mixed tocopherols occurs at the same dilution of the aqueous phase. This means that the effect of the tocopherols is mainly expressed at low dilutions, and when the system reaches higher dilutions, the tocopherols apparently have less effect on the flexibility and curvature of the interface. This may be ascribed to the steric hindrance of the tocopherol as the hydrophobic tails of the surfactant become more closely packed with increasing aqueous dilution, conferring less possibility for tocopherols to incorporate into the interface. Mixed tocotrienols have the same transitions as the mixed tocopherols, but maintain a higher level of solubilization capacity. This may refer to the nature of the phytyl tail of the vitamin which may be more convenient for its incorporation into the interface. Upon comparing the vitamin acetate to the free vitamin, it can be inferred that the tocopherol acetate is more located in the core of the droplets than in the interface, so that it is less affected by the structure of the micro-emulsion, and mainly affected by the concentration of the aqueous phase.

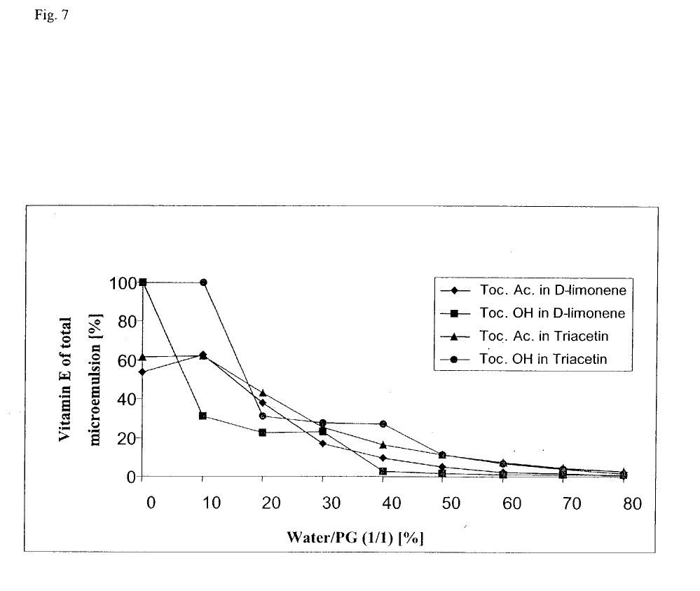

When D-limonene was replaced by triacetin the solubilization capacity of both alpha-tocopherol acetate and alpha-tocopherol increased along all of the dilution line (FIG. 7). A similar behavior could be observed for both oils. However, the first transition (drop in solubilization) for the free tocopherol with the triacetin was delayed to a higher dilution than with D-limonene. This would be attributed to the higher solubility of the aqueous phase in the oil phase at these low dilution levels, or rather to an interfacial effect induced by triacetin itself which could increase the solubilization of the aqueous phase, since it is a relatively hydrophilic oil and can have some interactions with the surfactant hydrophilic groups.

Having now fully described the invention, it will be understood by those of ordinary skill in the art that the same can be performed within a wide and equivalent range of conditions, formulations and other parameters without affecting the scope of the invention or any embodiment thereof. All patents, patent applications and publications cited herein are fully incorporated by reference herein in their entirety.

What is claimed is:

1. A composition for dispersion of a fat-soluble vitamin to give a clear, stable solution of the vitamin, the composition comprising the vitamin, an alcohol, a surfactant, and water.

2. The composition of claim 1, wherein the composition further comprises a polyol.

3. The composition of claim 2, wherein the polyol is selected from the group consisting of 1,2-propanediol, glycerol, 1,3-propanetriol, lactose, xylitol, sorbitol and glucose.

4. The composition of claim 3, wherein the polyol is 1,2-propanediol.

5. The composition of claim 3, wherein the polyol is glycerol.

6. The composition of claim 1, wherein the alcohol is ethanol.

7. The composition of claim 1, wherein the alcohol is a sugar alcohol.

8. The composition of claim 7, wherein the sugar alcohol is lactose.

9. The composition of claim 1, further comprising an oil.

10. The composition of claim 9, wherein the oil is D-limonene.

11. The composition of claim 9, wherein the oil is triacetin.

12. The composition of claim 9, wherein the oil is medium chain triglycerides.

13. The composition of claim 9, wherein the oil is long chain triglycerides.

14. The composition of claim 1, wherein the surfactant is a sorbitan fatty acid ester.

15. The composition of claim 14, wherein the sorbitan fatty acid ester is TWEEN 60.

16. The composition of claim 14, wherein the sorbitan fatty acid ester is TWEEN 80.

17. The composition of claim 1, wherein the surfactant is BRIJ 96.

18. The composition of claim 1, wherein the surfactant is a sucrose ester.

19. The composition of claim 18, wherein the sucrose ester is sucrose acetate isobutyrate.

20. The composition of claim 1, wherein the surfactant is a polyglycerol monoester.

21. The composition of claim 20, wherein the polyglycerol monoester is triglycerol monooleate.

22. The composition of claim 1, wherein the vitamin is vitamin E, vitamin K, vitamin D₃ or vitamin A.

23. The composition of claim 1, wherein the vitamin is in ester form.

24. The composition of claim 1, wherein the vitamin is tocopherol acetate.

25. The composition of claim 1, wherein the vitamin is tocopherol succinate.

26. The composition of claim 1, wherein the vitamin is tocotrienol.

27. A beverage comprising a nutritional amount of a fat-soluble vitamin in the form of an isotropic transparent solution.

28. The beverage of claim 27, which is selected from the group consisting of fruit and vegetable juices, vitamin drinks, mineral or clear bottled water, energy drinks, sports drinks, carbonated beverages, meal replacement drinks, punches and concentrated forms of beverages.

29. The beverage of claim 27, wherein the vitamin is vitamin E, vitamin K, vitamin D₃ or vitamin A.

30. A solid food composition comprising a nutritional amount of a fat-soluble vitamin in the form of an isotropic transparent solution.

31. The solid food composition of claim 30, which is selected from the group consisting of energy bars, hard candies, gummy type candies, gelatin desserts, dried fruit type candies, flavor emulsions, dried juice concentrates, and dried drink concentrates.

32. The solid food composition of claim 30, wherein the vitamin is vitamin E, vitamin K, vitamin D₃ or vitamin A.

33. A dried powder composition comprising a fat-soluble vitamin which upon mixing with an aqueous solution forms an isotropic transparent solution, said composition comprising the vitamin, an oil, a surfactant, and a sugar alcohol.

34. The dried powder composition of claim 33, prepared by the steps of mixing the vitamin in the oil with the surfactant and water to form a micro-emulsion and drying the nano-emulsion to remove the water.

35. The dried powder composition of claim 34, wherein the nano-emulsion is dried with a spray dryer.

36. The dried powder composition of claim 33, wherein the sugar alcohol is lactose.

37. The dried powder composition of claim 33, further comprising a polyol.

38. The dried powder composition of claim 37, wherein the polyol is selected from the group consisting of 1,2-propanediol, glycerol, 1,3-propanetriol, lactose, xylitol, sorbitol and glucose.
